(19) United States
(12) Patent Application Publication
(10) Pub. No.: US 2002/0058237 A1
(43) Pub. Date: May 16, 2002

(54) Mobile sport training mirror method and apparatus

(76) Inventor: Joseph F. Kernan, Park City, UT (US)

Correspondence Address: Joseph F. Kernan, PO Box 680182, Park City, UT, 84068-0182, US

(21) Appl. No.: 09/991,421

(22) Filed: Nov. 14, 2001

Related U.S. Application Data
(60) Provisional application No. 60/248,968, filed on Nov. 15, 2000.

(51) Int. Cl. G09B 9/00; G09B 19/00; A63B 69/00

(52) U.S. Cl. 434/247

(57) ABSTRACT

A new and improved visual analysis and self-review apparatus and method for subjects participating in sliding or rolling sports activities. The apparatus comprises a convex mirror (10) of substantial size with handles (21) and/or shoulder straps (31) for carrying. The handles or straps are attached to a casing (11) on the back or sides of the mirror. The mirror is carried in the vicinity of a subject, so that the subject can observe and learns from their reflected image. The shoulder straps may be used to transport the apparatus while a subject follows behind or beside a carrier. Alternatively, the carrier may grasp the handles or straps with their hands and direct the mirrored side towards the subject. The method also includes using, only, a substantially large convex mirror, with no straps, handles, or other carrying attachments. The apparatus may be used in such activities as skiing, skating, cycling, skateboarding, and snowboarding.

### CROSS REFERENCE TO RELATED APPLICATIONS

This application is entitled to the benefit of Provisional Patent Application Ser. No. 60/248,968 filed Nov. 15, 2000.

### FEDERALLY SPONSORED RESEARCH

Not Applicable

### SEQUENCE LISTING OR PROGRAM

Not Applicable

### BACKGROUND

1. Field of Invention

The present invention relates generally to image projection systems and mirrors, specifically to training mirrors that are used in sports where the participants are sliding or rolling, such as skiing, snowboarding, ice skating, in-line skating, skateboarding and cycling.

2. Description of Prior Art

Mirrors and video projection systems have been used to train various performers and sporting participants. However, prior art mirrors and video systems have been ineffective in providing adequate visual feedback to participants in rolling and sliding sports, such as skiing, snowboarding and skating.

Fixed Mirrors

Fixed mirrors are common for activities such as dance, aerobics and weight training. Typically, large sheets of reflectively coated glass are attached to a wall. But, the activities must be performed in a confined area proximal to the wall. Ski instructors have tried placing several plate glass mirrors on a ski slope, so that skiers could see themselves as they approach the mirrors. But, to see their turns, skiers have to ski within a corridor that is no wider than the mirror. Most turns are at least ten to fifteen feet wide. Thus, to stay in front of the mirror, the mirror must be at least ten feet wide across the hill. With a large stationary mirror, people must also avoid crashing into it. It is difficult to set up a huge mirror on a slope so that people could see themselves while skiing, but avoid crashing above it and sliding into it.

Additionally, because most ski slopes are not completely flat (like dance floors), the mirror may not be able to face a subject who is uphill from it. For example, the mirror wouldn't reflect a subject if the slope is convex or concave and the subject is a far distance from the mirror. Fixed mirrors only work in limited areas, of a short distance, where the slope is graded to have an even pitch. Grading would result in additional costs to the ski resort. If a skier wanted to see their image during an entire ski run, many fixed mirrors would have to be staggered up the hill, with much more grading, because ski runs are often very long.

Additionally, to see one's reflection from the side, there would have to be mirrors on the side of the slope. It would be expensive and difficult, if not impossible, to construct mirrors down the side of a ski slope. The mirrors would have to be perfectly lined up and angled, so that they function as one big mirror. Otherwise, the skier's image would shift as the skier passes each seem between the many mirrored sheets of glass. Using fixed mirrors in other large uneven areas, such as around streets and skateboard parks would have similar difficulties. Thus, fixed mirrors are not very useful for training people participating in rolling and sliding sports activities.

Fixed Indoor Ski Mirror

U.S. Pat. No. 3,047,291 by Hall (1962) covers an indoor ski practice slope with a giant belt driven carpet that rotates uphill as skiers practice turning downhill. The indoor slope includes a mirror which is angled downward from its mount above skiers. Skiers may look up at the mirror while sliding on the giant rotating carpet. Hall's training mirror is not perpendicular to the carpet, and thus it reflects the subject's image from a limited area of the carpet. It takes practice and concentration for users to remain skiing in the limited viewing area. Skiers must maintain an equal downward speed to the upward moving carpet. Indoor carpet skiing centers are rare, and thus they are not available to most skiers. Additionally, they only simulate the sensations of skiing on an actual slope. It would not be practical to position a mirror like Hall's above an outdoor ski slope. Skiers would only get a brief glimpse of their image as they pass under it.

Snowmobile Carried Mirrors

In Park City, Utah, people have witnessed cross-country track skiers training with a large flat mirror that was carried forward by a snowmobile, possibly on an attached trailer. On prepared cross-country courses, track skiers maintain a generally straight-forward path where they slide their skis within two railroad-track like grooves. To reflect a track skier, the mirror must be four to six feet high and have a width of at least three feet. This permits track skiers to see their image while following behind or beside the mirror. However, snowmobiles are not usually permitted on cross-country courses because they flatten the grooves with their tractor belts. Flattening the grooves also changes the very technique of the athlete being analyzed, because they can't ski in a groove.

The snowmobile with mirror would not work with downhill (alpine) skiers on traditional ski slopes. The mirror would have to be over ten feet wide for skiers and snowboarders to see themselves while making small to medium radius turns. Additionally, a snowmobile doesn't ride as smoothly as a car, so the mirror would vibrate. This makes viewing difficult. The larger the mirror, the more problems with vibration. Additionally, a ten foot wide mirror would be cumbersome to drive around and difficult to cover and store. A large flat mirror could also reflect the sun and temporarily blind people skiing by.

Furthermore, it is not practical to use mirrors on snowmobiles in lessons at ski resorts. Resorts would be unlikely to allow snowmobiles carrying large mirrors to zigzag and make “S” turns down the slopes. The sight and noise would detract from the peaceful mountain environment. The engine noise would interfere with communications between the instructors and students. People could run into them. At ski resorts, snowmobiles typically steer clear of skiers and snowboarders because they are not maneuverable enough to suddenly avoid a person that turns or falls in front of it. Furthermore, it is costly to provide snowmobiles with mirrors and drivers for lessons. Thus, mirror carrying snowmobiles are not appropriate for training skiers or snowboarders at downhill ski resorts.

Golf Training Mirrors

The numerous golf training mirror patents, including U.S. Pat. No. 5,174,576 by Lee in 1992, are comprised of flat or convex mirrors with stands to hold them upright. These mirrors are placed next to golfers as they practice swinging their clubs. These mirrors are not appropriate for sliding and rolling activities, because users must remain in front of the stationary mirrors. It would not be very useful to place these mirrors on ski slopes.

Cosmetic Mirrors

Cosmetic mirror patents, including U.S. Pat. No. 4,707,087 by Van Zandt in 1987, and U.S. Pat. No. 6,099,133 by Wright in 2000, have small flat mirrors that are mounted on the upper torso of a user. These mirrors are not intended for learning activities and they would not function as training mirrors. Wright and Van Zandt's flat mirrors show the face, but are too small for subjects to see themselves perform an activity, like skiing.

Convex Mobile Mirror on a Ski

U.S. Pat. No 5,037,303 by Irwin (1991) provides a convex mobile mirror for skiers and snowboarders. Irwin's mirrored training device is a small convex mirror that is affixed to the front of a ski or other board-type athletic device. This novelty mirror purports to be a useful training device, but it has numerous disadvantages. First, it is dangerous for skiers or snowboarders to look down to watch their reflection in a mirror on their skis. They may crash into a person or a tree if they are not looking up and forward. Looking down at one's equipment also negatively impacts a skiers balance. Inner ear receptors, that are used for balancing, are thrown off by the forces created turning. Thus, skiers need visual clues, such as having trees or the horizon in their peripheral view, to help them balance. Skiers can't get these visual clues when they can only see the snow.

Additionally, many factors would make it difficult to see ones reflection in Irwin's mirror device. Snowboards and skis flex as users turn. This flexing, along with the normal inconsistencies in the snow surface, causes vibration in a persons skis or snowboard. The vibration would make it difficult to see one's reflection in a mirror. Advanced skiing techniques require substantial edging. To edge, skiers often tilt the skis onto their sides, (with their ankles, knees, and hips), while their torso stays upright. This causes the ski mounted mirror to be directed to the side of the skier, reflecting little or none of the skiers image. During short radius “windshield wiper” turns, the skis are pivoted like a propeller about an axis under each foot. As the upper body faces downhill, the tips are quickly redirected to alternatively point to the right and left side of the slope. It would be strenuous and dizzying to try to keep one's eyes on ski-tip mounted mirrors as they are pivoted quickly from side to side. Additionally, it is not functional to turn ones head from side to side during rapid short radius turns. Expert skiers learn to keep their upper body and eyes directed forward. Furthermore, a ski or snowboard can only practically fit a smaller mirror, and thus the subjects image is too small to see well enough to analyze. Additionally, subjects will not be able to see the mirror after it becomes covered with snow. Snow frequently builds up on the top of skis and snowboards when turning in many snow conditions, including on hard packed snow surfaces, in slush, and in fresh powder. Thus, Irwin's training mirror is not very useful in providing skiers, and other sliding sport participants, with a quality image for improving their athletic technique.

Video Recording Systems and Projections

Video recording was first used to train skiers in the 1960's on the ski slopes in Sun Valley, Id. The main disadvantage of video systems like Sun Valley's is that they do not provide immediate feedback. Skiers must first be filmed, then stop to review the tape after its rewound. They must be filmed again and again each time they adjust their skiing technique. The repeated stopping is a hassle for skiers that want to keep moving. Most importantly, with a time-delayed feedback, skiers often make too drastic of a change, the wrong change, or no change at all. Accordingly, skiers get frustrated when they stop to review the video, because they see no improvement in their skiing.

Additionally, the resolution of the viewing screen may be poor, especially when users review the tape on the camera's internal screen. Internal camera screens are small and their resolution never reaches the clarity of televisions. Thus, to review the tape, the camera is often connected to a television at a video review station. Outdoor stations must be provided with a power source and must be covered. The cover keeps glare off the television screen and protects the television from bad weather. To view repeated ski runs, students have to take the chair lift up and then ski down to the video review station again and again. This process can take hours. To save time students may have to ski on slopes that are near the video station, instead of on preferred slopes. An indoor video station is logistically easier, but going inside causes more delays. Thus, it is inconvenient to use video recordings to train skiers. Most importantly, with delayed feedback, skiers and snowboarders are unable to monitor their performance at the moment they experiment with changes.

Projection Screens

U.S. Pat. No. 3,408,067 by Armstrong (1968) covers belt driven ski simulator with a projection screen showing another skier. Armstrong's ski simulator does not provide the subject with a reflection, or a projection, of their own image. U.S. Pat. No. 3,353,282 by Sneed (1967) and U.S. Pat. No. 4,015,344 by Michaels et al. (1977) cover video and/or mirror images of a pupil and an instructor with immediate visual feedback. The pupil performs activities in front of at least one large stationary screen and possibly a mirror. If a screen is outdoors, the glare of the sun would make it difficult to see. Many ski slopes face north to protect the snow from melting. Thus, a screen at the base of the slope, facing uphill, would face southward into the sun. It may not be possible to shade the screen and still permit skiers to see themselves. Furthermore, while skiing outdoors, a pupil would be unable to see the images in a mirror or screen if they are too far away, possibly 50 feet away from a moderately sized unit. Additionally, Sneed and Michaels's systems are too large to transport down hills in front of skiers. Even if a mobile system were developed with reduced sized screens mounted within a pupil's helmet or goggles (for shading), and radio transmission of the data from the camera to the screen, the resolution and clarity of small camera screens is not adequate. Furthermore, it would be very costly to provide such a mobile system plus a camera person for training skiers. Additionally, the flat mirror would have to be much larger than the four foot wide mirror in Sneed and Michaels systems if it is to permit a skier to see themselves making turns. A flat mirror that is small and easy to transport would not reflect the subjects entire body image.

### SUMMARY

The invention is a convex mirror of substantial size with shoulder straps and/or handles for carrying. A carrier transports the convex mirror in the vicinity of a subject, who observes their own image, while participating in a sliding or rolling sports activity.

### OBJECTS AND ADVANTAGES

Accordingly, the objects and advantages of my training mirror are as follows:

(a) to provide participants in sliding and rolling sports, with immediate visual feedback;

(b) to permit subjects to see their moving image from front, side, and diagonal views;

(c) to provide subjects with a high resolution and adequately sized, image for analysis;

(d) to provide an affordable apparatus that is easy to transport, use, and store;

(e) to permit subjects to see their own image while making short or long radius turns;

(f) to permit participants to perform their activity without disturbing the mirror angle;

(g) to prevent the mirror from collecting snow from the ground;

(h) to permit subjects to use the apparatus where desired, even in large undefined areas;

(i) to function on convex and concave mountain terrain and various road surfaces;

(j) to permit users to analyze their performance image while experimenting with changes in technique, while glancing at a pro's demonstration, and while receiving verbal instruction;

(k) to allow a mirror carrier to easily adjust the position of the mirror to assure that the subject can see their image at all times;

(l) to provide a training mirror that is not dangerous to run into;

(m) to encourage participants to look ahead for safety and for proper technique;

(n) to permit the subject to see downhill obstacles while using the mirror, and to see other riders coming up from the rear in the mirror, and thus help avoid collisions;

(o) to permit a person to carry the mirror and keep it steady;

(p) to provide an image that is not overcome by glare from the sun;

(q) to dissipate sun that is reflected off of the mirror.

Further objects and advantages will become apparent from consideration of the ensuing description and drawings.

### DRAWING FIGURES

FIG. 1A shows a training mirror strapped to the back of a carrier leading a subject.

FIG. 1B shows the rear side of the training mirror with carrying straps and handles.

FIG. 1C shows a carrier holding a training mirror in their hands while facing a subject.

FIGS. 1D, 1E & 1F shows training mirrors positioned at various angles on a carrier's back.

FIG. 1G shows the components for assembling the mirror and protective casing.

FIG. 2 shows a training mirror with shoulder straps, but no handles.

FIG. 3 shows a training mirror with handles, but no shoulder straps.

### REFERENCE NUMERALS AND LETTERS IN DRAWINGS

C Carrier skiing forwards

C′ Carrier skiing backwards

S adult subject skier

S′ child subject skier

10 convex mirror

11 fiberglass disc

12 rubber stripping

12b casing bottom

12t casing top

13 screw

14 screw

15 metal plate

16 hole in rubber stripping

17 hole in rubber stripping

18 hole in disc

19 hole in disc

20 cement trowel

20p trowel plate

20r rivet

21 cement trowel

21b handle bottom

21L handle length

21p trowel plate

21t handle top

22 strap attachment position

23 strap attachment position

24 strap attachment position

25 strap attachment position

30 padded shoulder strap

30b buckle

30r rivet

30w washer

31 padded shoulder strap

31b buckle

40 large plate

### DESCRIPTION

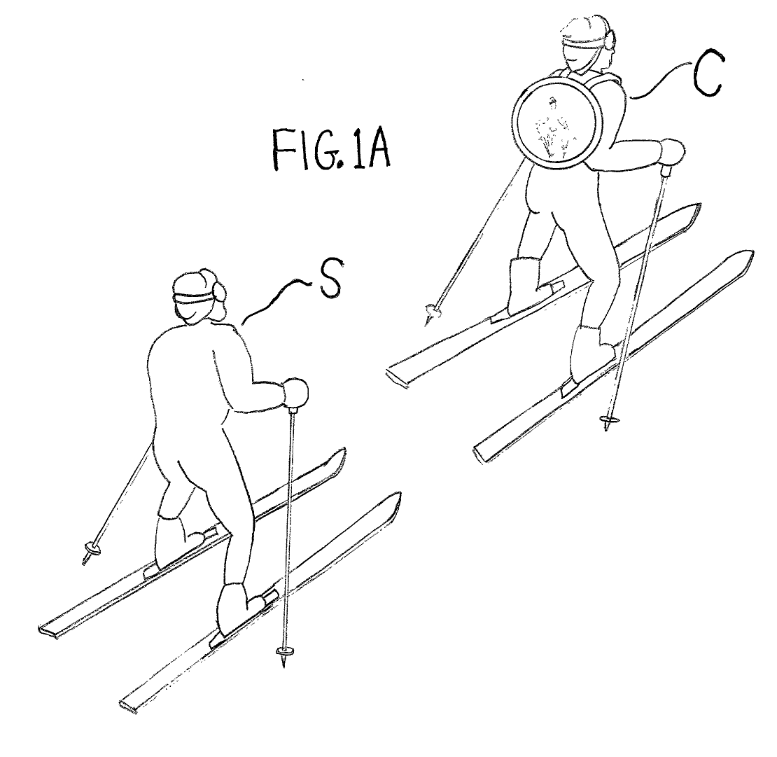

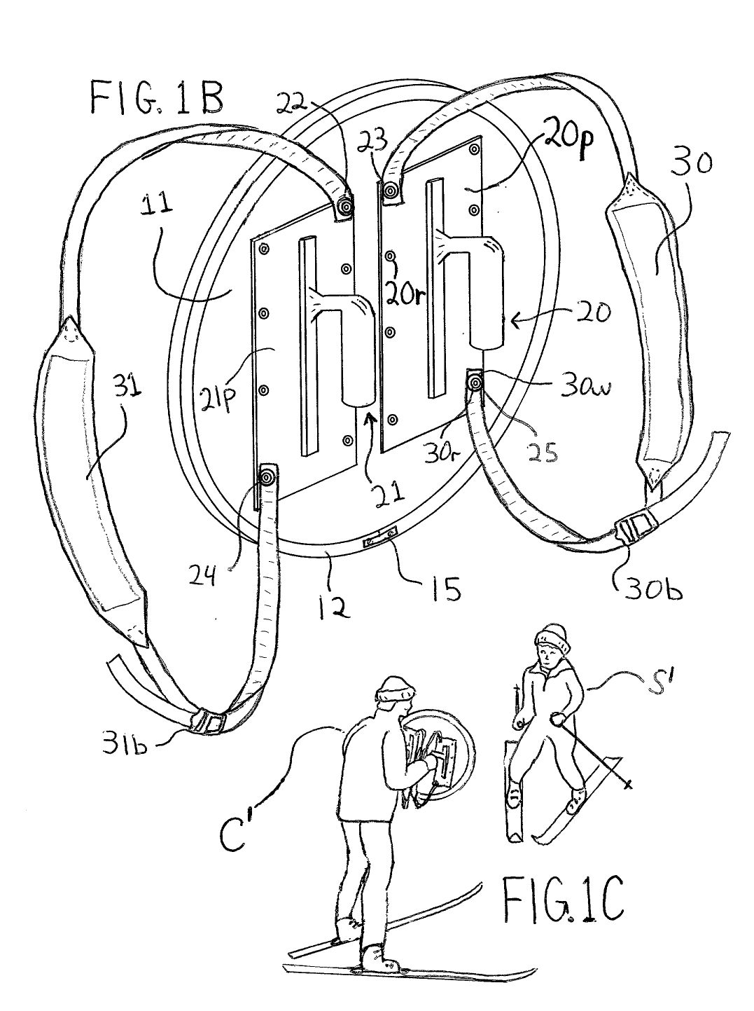

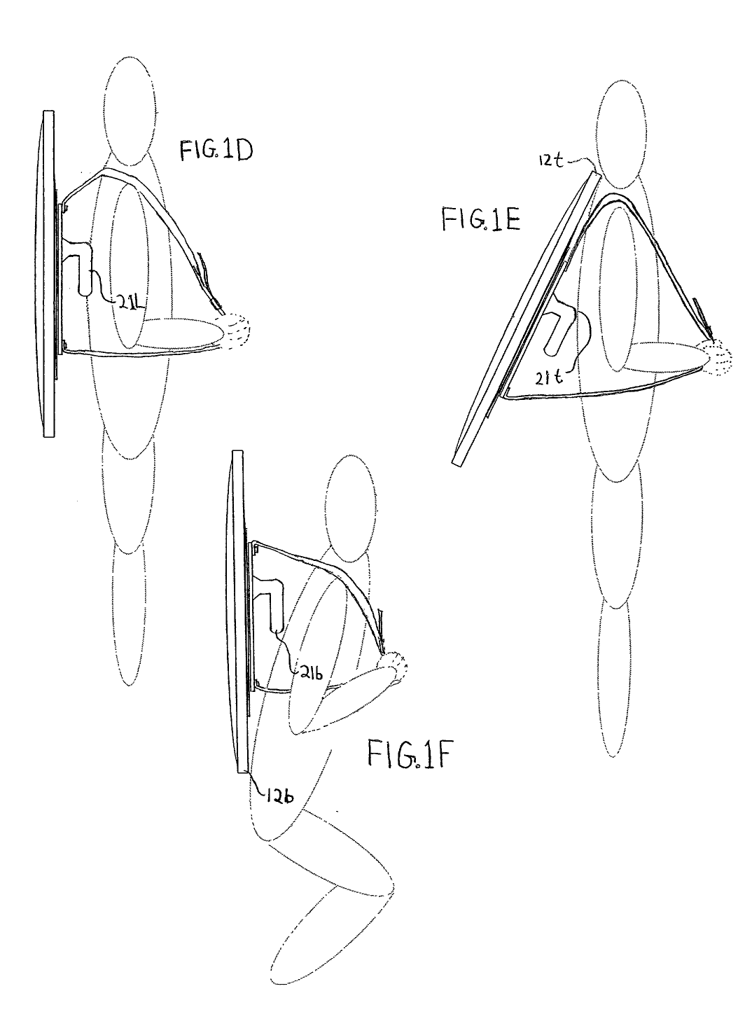

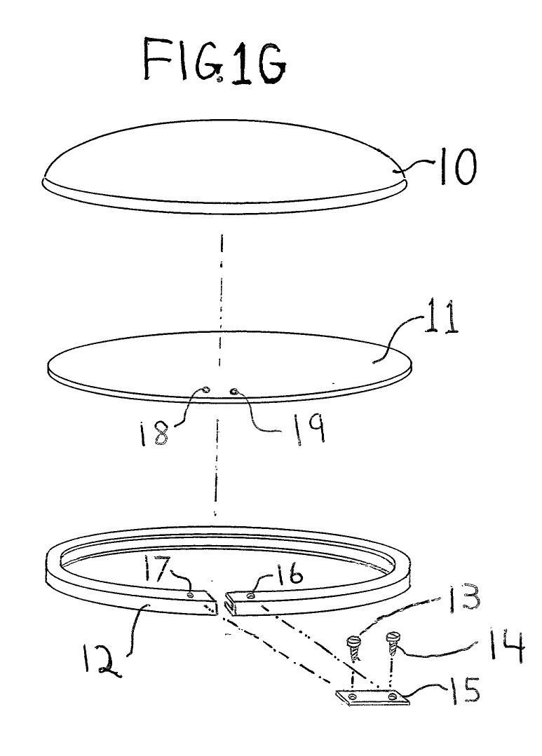

FIGS. 1A to 1G—Preferred Embodiment—Mirror with Straps and Handles

The training mirror is a visual analysis and self-review device for subjects participating in one of many sliding and rolling sports activities, including alpine snow skiing. FIG. 1A shows a preferred embodiment of my training mirror attached to the back of a ski carrier C, as a subject S follows.

Convex Mirror and Casing

The assembly of the training mirror and its casing is shown in FIG. 1G. Mirror 10 is a convex mirror of a substantial size. It is constructed of impact-resistant plastic. Mirror 10 is placed on top of a disc 11, and then the combination is flipped upside-down, with disc 11 on top. Disc 11 is made of a rigid lightweight and high-density fiberglass. Then, a rubber stripping 12 is wrapped around the circumference of the mirror and disc to complete the mirror's casing. Then, two screws 13 & 14 are run through two holes in a metal plate 15, through two holes 16 and 17 in rubber stripping 12, and then secured into two holes 18 and 19 in disc 11. In FIG. 1B, plate 15 is shown on bottom of rubber stripping 12. The rubber stripping and disc encase the mirror. The preferred size of the mirror is twenty six to thirty six inches in diameter. The viewing area of the mirror should be approximately fifteen feet across when the subject is about ten feet away from the mirror. Thus, the curvature of the convex mirror is reduced for larger mirrors and increased for smaller mirrors.

Handles and Shoulder Straps

For carrying, the preferred embodiment of my training mirror includes handles and padded shoulder straps. These carrying attachments permit a carrier person to transport the mirror in the vicinity of a subject, and directed it towards the subject to allow them to see their reflection while engaged in the activity. In FIG. 1B, two cement trowels 20 and 21 with carrying handles and attachment plates are shown. The trowels with handles are attached to disc 11 on the back of the mirror. For attachment, holes are drilled through the perimeter of plates 20p and 21p on the base of trowels 20 and 21, and through disc 11. Rivets are inserted and spread out within the holes, including rivet 20r. FIG. 1C shows carrier C′ holding onto the handles while skiing backwards and facing subject S′.

The rear side of the training mirror in FIG. 1B shows two shoulder straps. Shoulder straps 30 and 31 are attached at attachment positions 22, 23, 24, and 25. The attachment of strap 30 at position 25 is completed by running a rivet 30r, through a large washer 30w, through the shoulder strap, through trowel plate 20p, and finally through disc 11 on the back of the mirror. The back of the rivet is spread out on the rear of disc 11 with a rivet gun. Rubber stripping 12 connects the disc and carrying attachments to the sides of the mirror.

The straps in FIG. 1B include two buckles 30b and 31b. FIGS. 1D, 1E and 1F show several positions of the mirror. In FIG. 1D, the long bar-like portion of the handle (handle length 21L) is shown against the carrier's back. In FIG. 1E, the top of the handle (handle top 21t) and the top of the mirror (casing top 12t) are shown against the carrier's back. In FIG. 1F, the base of the handle (handle bottom 21b) and the mirror base (casing bottom 12b) are shown against the carrier's back.

FIGS. 2, 3 and 1G (Part 10)—Additional Embodiments

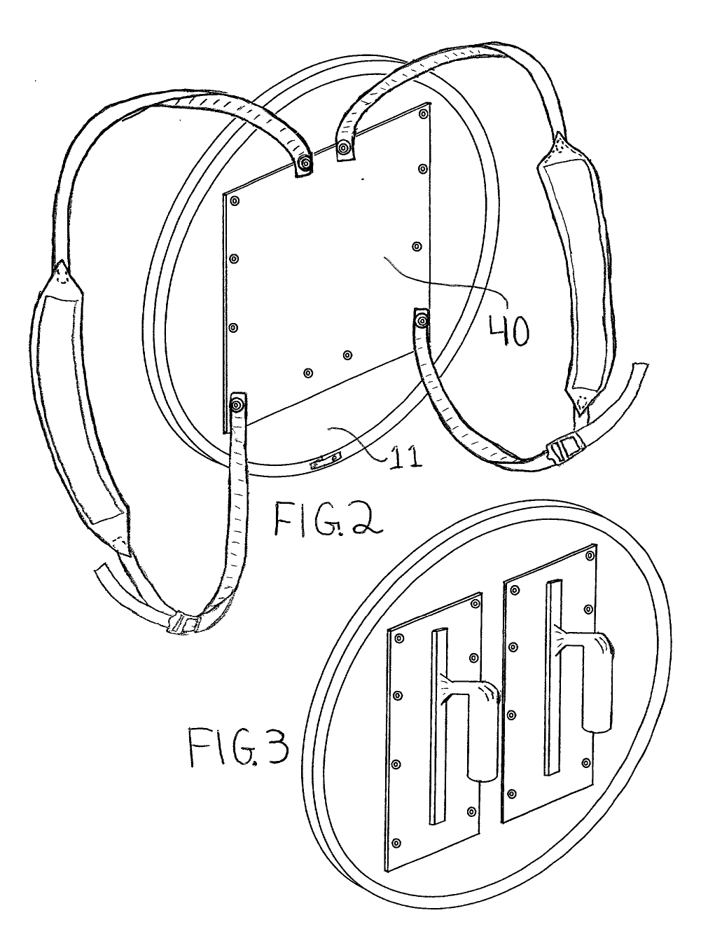

Additional embodiments are shown in FIGS. 2, 3 and 1G. In FIG. 2, a training mirror is shown with two carrying straps, but no handles. It is constructed like the preferred embodiment, except that a large plate 40 is riveted to disc 11, rather than having two trowels. FIG. 3 shows a training mirror with two trowels, but no straps. Mirror 10 in FIG. 1G is not only a component of the preferred embodiment, it is also an additional embodiment with no carrying attachments. To be used alone, mirror 10 should be made of a sufficiently thick and rigid impact-resistant material.

Operation—FIGS. 1A to FIG. 3

My mobile sport training mirror is used for participants of rolling and sliding sports activities, such as for skiers (see FIGS. 1A and 1C). As shown in FIG. 1A, the preferred training mirror may be strapped to the back of a skier, so that another skier may follow and see their reflection. Before starting downhill, the carrier should adjust the angle of the mirror upward, or downward, so that the subject who is following can see their reflection. Small adjustments in the mirror angle may be made by the carrier if they lean their upper body slightly forward or backward. The shoulder straps may be shortened and cinched against the body as shown in FIG. 1A. Alternatively, the straps may be lengthened and held in the carrier's hands as shown in FIGS. 1D, 1E and 1F. The cinching or holding of the straps prevents the mirror from shifting and vibrating on the carrier's back.

As shown in FIGS. 1D, 1E, and 1F, large adjustments in the angle of the mirror can be made by resting various sections of the handles and the casing against the carrier's back. As shown in FIG. 1D, the carrier may rest handle length 21L against their back to keep the mirror parallel with their back. As in FIG. 1E, the carrier may rest the handle top 21T and casing 12t against their back to direct the mirror upward. This position is common when the carrier leads an advanced subject down a steeper slope, because the subject remains at an elevation somewhat above that of the carrier. As shown in FIG. 1F, a carrier can also hold the shoulder straps in their hands and rest casing bottom 12b and handle bottom 21b against their back. This will keep the mirror perpendicular, while allowing a carrier to lean their upper body forward at higher speeds. Additionally, for a child, or for a handicapped person riding on a sit-ski, the carrier may keep their body upright and use the downward mirror positioning shown in FIG. 1F to angle the mirror down towards the subject.

Operation Cont.

An instructor who is a skilled mirror person should be the mirror carrier to maximize the benefits of using the training mirror. The carrier should ski in a wedged manner (arranging one's skis in a “V”) to control speed. As shown in FIG. 1A, beginner subject S can follow carrier C as they ski straight or make gradual turns with wedged (or snowplowing) skis. For advanced skiers, with their skis positioned in a parallel manner, the carrier should ski straight forward in a slight breaking wedge, maintaining a consistent speed. A subject may practice, short to medium radius parallel turns approximately ten feet up hill from the person carrying the mirror. The mirror carrier can minimize mirror vibration by using their body as a shock absorber over uneven terrain. Freshly groomed terrain is also recommended to minimize vibration. For safety, the carrier should look ahead to avoid obstacles, and turn gradually across the hill when stopping. While following, beginner skiers may alternatively look at the wedge position demonstrated by a carrier who is an instructor and then at their own image. If the subject is an advanced parallel skier, or is a snowboarder, a second instructor can perform demonstrations for the subject to model. The second instructor should make short radius turns while remaining near one side of the carrier.

Operation Cont.

As shown in FIGS. 1A and 1C, the carrier may ski forwards or backwards when transporting the mirror. The carrier should ski backwards if the subject is making very wide turns, for example turns that are wider than fifteen feet across the hill. Skiing backwards allows the carrier to see the subject turn and direct the mirror to keep it focused on them. The carrier points and steadies the training mirror while holding it by its handles. Most snowboarders would prefer a carrier that skis backwards because they often make wide radius turns. As shown in FIG. 1C, carrier C′ is close enough to provide coaching to a subject S′.

Additionally, to provide a subject with a profile view, a carrier can direct the mirror to the side as a subject skis beside them. For a diagonal (front and side) perspective, a subject should make short radius turns off to one side and slightly uphill from the mirror carrier. The carrier may be skiing forwards or backwards when providing this perspective. It is easier to direct the mirror diagonally when skiing backwards and holding the handles. If skiing forward with the training mirror on their back, the carrier can ski straight while rotating their torso 45°. Alternatively, a forward skiing carrier may transport the mirror with one handle, like a shield on the outside of their forearm with their palm facing away from the mirror back and under the handle. The carrier opens their arm to direct the mirror diagonally uphill.

The embodiments shown in FIG. 1A through FIG. 3A allow a subject to review their image as they continuously modify and experiment with changes in their technique. Thus, a skier, snowboarder, or other sliding or rolling sports participant can immediately judge the success of major or minor changes. A subject can also use the device as a rear view mirror. The training mirror in FIG. 2 is strapped onto a carrier much like the preferred embodiment, except that disc 11 and plate 40 rest flat against the carrier's back. Adjustments in the mirror angle are made by leaning forward or backward and arching one's back. Alternatively, to use the FIG. 2 mirror device as if it had handles (like the embodiment in FIG. 1C), the straps may be wrapped around the carriers hands as they ski backwards. The training mirror in FIG. 3 is used by grasping the handles like the preferred embodiment in FIG. 1C. Additionally, the carrier could simply hold the training mirror in FIGS. 2 or 3 by the outer edge of their casing with both hands.

Likewise, mirror 10 in FIG. 1G, an additional embodiment, can be held without any casing, handles, or straps. The carrier would simply hold the plain convex mirror (10) in FIG. 1G by its sides in their hands while skiing backwards, or forwards (with one's hands behind one's back), in the vicinity of the subject. Although, it may be easier to drop the mirror, the carrier is still able to direct the reflective side of the plain mirror towards the subject, and the subject can observe and learn while engaged in the activity. Thus, mirror 10 could be used to provide a subject with a visual image of their body while participating in one many sliding and rolling sports activities, including alpine snow skiing. This training method only requires that a convex mirror be of a substantial size be carried in the vicinity of a moving subject who is engaged in the activity.

Function of Parts

The parts of the training mirror apparatus shown in FIGS. 1A, 1B and 1G provide the following functions: The convex shape of mirror in FIG. 1A permits a carrier to transport a reasonably sized mirror, while reflecting the broad image of the subject's body and their immediate surroundings. Mirror 10 also provides a high resolution image of the subject, exceeding the clarity of any camera screen or projection. Additionally, the mirror image is not overcome by glare from the sun, and the convex shape dissipates sun reflections. In FIG. 1G, disc 11 protects the back of the mirror from being scratched, and provides a casing along with rubber stripping 12 to stabilize the mirror. Mirrors that are made of a thin and flexible plastic require a casing for stability. Screws 13 & 14 tightly connect the rubber stripping with metal plate 15. In FIG. 1B, cement trowels 20 and 21 provide handles for grasping and plates to spread out the stress from each handle's attachment to the disc. The open side of the handle allows users to easily slip their palm in and out from under the handle. The round ends of the handles is for comfort when they are against the carriers back in Figs E and F. Rivet 20r is one of the many rivets that attach the trowels. Shoulder straps 30 and 31 allow people to carry the mirror on their back. Large washer 30w keeps the strap from pulling off over the rivet head. Buckles 30b and 31b are used to hold the straps at the desired length after adjusting them.

In summary, this training method is accomplished by providing a convex mirror of substantial size, which is carried in the vicinity of a moving subject, with the reflective side of the mirror directed towards the subject, so that the subject can observe and learn while engaged in an activity. The training mirror is used in sliding and rolling sports activities, such as, for example, snowboarding, skiing, ice skating, snow skating, in-line skating, skateboarding, mountain boarding, scootering, mountain biking, and cycling.

Conclusion, Ramifications, and Scope

Accordingly, the reader will understand that my training mirror in its several embodiments provides a new and improved apparatus and method for learning sliding and rolling sports. It has advantages for skiers, snowboarders, and other types of users. It accomplishes the objectives set forth above for a visual analysis and self-review device. Although the descriptions above contain several specificities, these should not be construed as limiting the scope of the invention but merely providing illustrations of some of the presently preferred embodiments of this invention. Some of the many alternative variations are listed below.

The casing may be eliminated. If the mirror has no casing, the handles or straps could be glued or fastened directly to the back or sides of the mirror. The mirror casing can be made in various forms with a variety of materials. The casing may be made of one piece, such as molded plastic or pressed metal that encases the back and edges of the mirror. The handles may also be molded into the device as part of the mirror casing. For example, hand impressions could be pressed into the outside edges of a thick plastic casing. Alternatively, the casing on back could be bowed out and voids (or hand holds) could be cut into each side to insert one's hands up to the thumbs like pant pockets. The handles can come in many other forms. Alternative carrying attachments include a steering wheel, handle bars, or one or more knobs, bars, hand grips, hand holds, or loops. Additionally, there may be one handle instead of two.

Conclusion, Ramifications, and Scope Cont.

The disc portion of the casing can be made of numerous rigid materials. Plate 40, in FIG. 2, may be eliminated as long as disc 11 is constructed with a high-density material (such as aluminum) that will prevent the rivet at the end of the strap from pulling through the material. If the disc is made of a material with low density (like paperboard), then rivet washers should be included on the end of the rivets between the disc and the mirror (not shown) for additional strength. Accordingly, to add the rivet washers, the trowel plates would be attached to the disc prior to attaching the convex mirror and rubber stripping.

Additionally, the straps can come in a multitude of materials and arrangements. Carrying attachments that are an alternative to straps include ropes, elastic bands, cables, harnesses, hooks. Additionally, there could be just one strap, or the addition of waist straps and chest straps. The straps or handles can be attached to the mirror with numerous types of attachments including interlocking fabric fasteners, adhesives, magnetic attraction, resilient sleeves, hooks, plastic snaps, and various fasteners. Additionally, the size or type of convex mirror may be altered. For example, lead coated impact-resistant glass, metal coated plastic, or chromed metal may be used. Glass mirrors should have a nylon fabric coating on back of the glass to prevent separation of glass during breakage. Alternative carrying techniques include strapping the training mirror to any part of the body, including a person's waist, torso, backpack, arm, or head.

As shown above, it is evident that many components can be altered, deleted or substituted with an equivalent component. Additionally, there are many ways to use the various embodiments of the training mirror. Thus the scope of the invention should be determined by the appended claims and their legal equivalents, rather than by the examples given.

I claim:

1. A visual analysis and self-review device for a subject participating in one of many sliding and rolling sports activities, such as, for example, alpine snow skiing, comprising:
(a) a convex mirror of a substantial size,
(b) a first means for carrying that permits a carrier person to transport said mirror,
(c) whereby said mirror may be carried in the vicinity of a subject, and directed towards the subject, so as to allow the subject to see their reflection while engaged in the activity.

2. The visual analysis and self-review device of claim 1 wherein said first means for carrying is selected from the group consisting of straps, ropes, elastic bands, cables, harnesses, hooks, loops, knobs, hand grips, hand holds, wheels, and handle bars.

3. The visual analysis and self-review device of claim 1 wherein said first means for carrying includes at least one strap, so as to permit said carrier to transport said training device by said strap.

4. The visual analysis and self-review device of claim 1 wherein said first means for carrying includes at least one handle, so as to permit said carrier to direct said training device with their hand.

5. A method for providing a subject with a visual image of their body while participating in one of many sliding and rolling sports activities, such as, for example, alpine snow skiing, comprising the steps of:
(a) providing a convex mirror of substantial size,
(b) carrying said convex mirror in the vicinity of a moving subject,
(c) directing the reflective side of said convex mirror towards said subject,
(d) whereby said subject may observe and learn while engaged in the activity.

6. The method of claim 5 wherein said subject is participating in an activity selected from the group consisting of snowboarding, skiing, skating, skateboarding, mountain boarding, scootering, mountain biking, and cycling.

7. A visual analysis and self-review device for a subject participating in one of many sliding and rolling sports activities, such as, for example, alpine snow skiing, comprising:
(a) a convex mirror of a substantial size,
(b) a carrying attachment selected from the group consisting of straps, ropes, elastic bands, cables, harnesses, hooks, loops, knobs, hand grips, hand holds, wheels, and handle bars,
(c) wherein said carrying attachment is affixed to said convex mirror,
(d) whereby said convex mirror may be carried in the vicinity of a subject, and directed towards the subject, so as to allow the subject to see their reflection while engaged in the activity.

8. The visual analysis and self-review device of claim 7 wherein said carrying attachment is affixed to the back of said convex mirror.

9. The visual analysis and self-review device of claim 7 wherein said carrying attachment is affixed to the side of said convex mirror.
